(19) United States
(12) Patent Application Publication
(10) Pub. No.: US 2006/0272334 A1
(43) Pub. Date: Dec. 7, 2006

(54) PRACTICAL METHOD FOR IMPROVING THE EFFICIENCY OF COGENERATION SYSTEM

(76) Inventors: Pavol Pranda, Lisle, IL (US); Tailai Hu, La Grange PK, IL (US)

Correspondence Address: Linda Russell;Air Liquide Intellectual Property Dept., 2700 Post Oak Blvd., Suite 1800, Houston, TX, 77056, US

(21) Appl. No.: 11/381,109

(22) Filed: May 1, 2006

Related U.S. Application Data
(60) Provisional application No. 60/686,295, filed on Jun. 1, 2005.

(51) Int. Cl. F02C 6/04

(52) U.S. Cl. 60/783; 60/784

(57) ABSTRACT

Systems and methods for exhaust gas recirculation in which a desired oxygen concentration is maintained for stable combustion at increased recirculation rates. Exhaust gas of an energy generation system is divided and reintroduced at different locations of the system.

### CROSS-REFERENCE TO RELATED APPLICATIONS

This application claims the benefit under 35 U.S.C. § 119(e) to provisional application No. 60/686,295, filed Jun. 1, 2005, the entire contents of which are incorporated herein by reference.

### BACKGROUND

The power generation research and development community faces an important challenge in the years to come: to produce increased amounts of energy under the more and more stringent constraints of increased efficiency and reduced pollution. The increasing costs associated with fuel in recent years further emphasize this mandate.

Gas turbines offer significant advantages for power generation because they are compact, lightweight, reliable, and efficient. They are capable of rapid startup, follow transient loading well, and can be operated remotely or left unattended. Gas turbines have a long service life, long service intervals, and low maintenance costs. Cooling fluids are not usually required. These advantages result in the widespread selection of gas turbine engines for power generation. A basic gas turbine assembly includes a compressor to draw in and compress a working gas (usually air), a combustor where a fuel (i.e., methane, propane, or natural gas) is mixed with the compressed air and then the mixture is combusted to add energy thereto, and a turbine to extract mechanical power from the combustion products. The turbine is coupled to a generator for converting the mechanical power generated by the turbine to electricity.

A characteristic of gas-turbine engines is the incentive to operate at as high a turbine inlet temperature as prevailing technology will allow. This incentive comes from the direct benefit to both specific output power and cycle efficiency. Associated with the high inlet temperature is a high exhaust temperature which, if not utilized, represents waste heat dissipated to the atmosphere. Systems to capture this high-temperature waste heat are prevalent in industrial applications of the gas turbine.

Examples of such systems are cogeneration systems and combined cycle systems. In both systems, one or more heat exchangers are placed in the exhaust duct of the turbine to transfer heat to feed-water circulating through the exchangers to transform the feed-water into steam. In the combined cycle system, the steam is used to produce additional power using a steam turbine. In the cogeneration system, the steam is transported and used as a source of energy for other applications (usually referred to as process steam).

A prior art cogeneration system typically includes a gas turbine engine, a generator, and a heat recovery steam generator. As discussed earlier, the gas turbine engine includes a compressor, a combustor (with a fuel supply), and a turbine. A compressor operates by transferring momentum to air via a high speed rotor. The pressure of the air is increased by the change in magnitude and radius of the velocity components of the air as it passes through the rotor. Thermodynamically speaking, the compressor transfers mechanical power supplied by rotating a shaft coupled to the rotor to the air by increasing the pressure and temperature of the air. A combustor operates by mixing fuel with the compressed air, igniting the fuel/air mixture to add primarily heat energy thereto. A turbine operates in an essentially opposite manner relative to the compressor. The turbine expands the hot and pressurized combustion products through a bladed rotor coupled to a shaft, thereby extracting mechanical energy from the combustion products. The combusted products are exhausted into a duct. Feed-water is pumped through the steam generator located in the duct where it is evaporated into steam. It is through this process that useful energy is harvested from the turbine exhaust gas. The turbine exhaust gas is expelled into the atmosphere at a stack.

Due to deregulation of the energy market and volatility in energy prices, many cogeneration operators prefer to have the option of shutting down the turbine assembly while retaining the steam generation capability of the cogeneration system. To enable operation of this fresh air mode, a furnace is disposed in the exhaust duct. The furnace provides an alternate source of hot gas for steam generation. To increase the efficiency of the fresh air mode, a portion of the exhaust gas may be recirculated back to the furnace. Generally, the efficiency of the fresh air mode increases with an increase in recirculation rate of the exhaust gas. Heat energy lost through the stack also decreases with an increase in recirculation rate of the exhaust gas. However, with the increase of the recirculation rate of exhaust gas, the oxygen concentration at the inlet of the furnace decreases, which, eventually adversely affects combustion stability (of the mixture in the furnace) and generates pollutants. Thus, maintaining stable combustion at the high recirculation rates of exhaust gas is problematic.

### SUMMARY

Embodiments of the present invention generally relate to an exhaust gas recirculation system which maintains a desired oxygen concentration for stable combustion at increased recirculation rates. In one embodiment, a method for generating heat energy is provided. The method includes the acts of mixing a first stream of exhaust gas with a stream of fresh air, thereby forming a first mixture; igniting the first mixture with a stream of fuel, thereby forming a second mixture; mixing the second mixture with a second stream of exhaust gas, thereby forming a third stream of exhaust gas; dividing the third stream of the exhaust gas into at least a fourth stream of exhaust gas and a fifth stream of the exhaust gas; and dividing at least a portion of the fifth stream of the exhaust gas into at least the first stream of exhaust gas and the second stream of the exhaust gas.

In another embodiment, a steam generator is provided. The steam generator includes a main duct; a furnace in fluid communication with the main duct. The furnace includes a combustion chamber having a first axial end and a second axial end and a burner located proximate to the first axial end. The steam generator further includes a heat exchanger having a first chamber physically separate from and in thermal communication with a second chamber, the first chamber either in fluid communication with the main duct or being part of the main duct, the first chamber in fluid communication with the second axial end of the combustion chamber; and a recirculation system. The recirculation system includes a first diverter damper in fluid communication with the first chamber of the heat exchanger and a recycle duct; the recycle duct in fluid communication with the diverter damper and a second diverter damper; the second diverter damper in fluid communication with the recycle duct and first and second recycle sub-ducts; a mixing damper in fluid communication with the first recycle sub-duct and fresh air; the first recycle sub-duct in fluid communication with the main duct at a location distal from the first end of the combustion chamber; and the second recycle sub-duct in fluid communication with the first end of the combustion chamber at a location proximate to the burner.

In another embodiment, a control system for use with a cogeneration system is provided. The control system includes a memory unit containing a set of instructions; a diverter damper configured to variably divide at least a portion of a first stream of recycled exhaust gas into at least a second stream and a third stream, wherein the second stream is mixed with fresh air to form a mixture; an oxygen sensor configured to measure an oxygen concentration of the mixture, the oxygen sensor in electrical communication with a processor; and a processor. The processor is configured to control operation of the diverter damper and perform an operation, when executing the set of instructions, including: comparing the measured oxygen concentration of the mixture with a predetermined oxygen concentration; and if the measured oxygen concentration is not substantially equal to the predetermined oxygen concentration, then adjusting the diverter damper so that the measured oxygen concentration will be substantially equal to the predetermined oxygen concentration.

In another embodiment, a method for generating heat energy includes operating a cogeneration system in a first mode in which a gas turbine engine is operated to produce energy, and operating the cogeneration system in a second mode in which the gas turbine engine disabled and a steam generation system operates to generate energy. The operation in the second mode includes flowing a combustible mixture into an ignition unit in order to combust the combustible mixture and produce exhaust gas; introducing a first recirculated portion of the exhaust gas at a location of the steam generation system upstream of the ignition unit; and introducing a second recirculated portion of the exhaust gas at a location of the steam generation system downstream of the ignition unit.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a process flow diagram of a cogeneration system, according to one embodiment of the present invention.

FIG. 2 is a schematic diagram of a cogeneration system, according to one embodiment of the present invention.

FIG. 3 is a simplified end view of a duct burner, according to one embodiment of the present invention.

### DESCRIPTION OF PREFERRED EMBODIMENTS

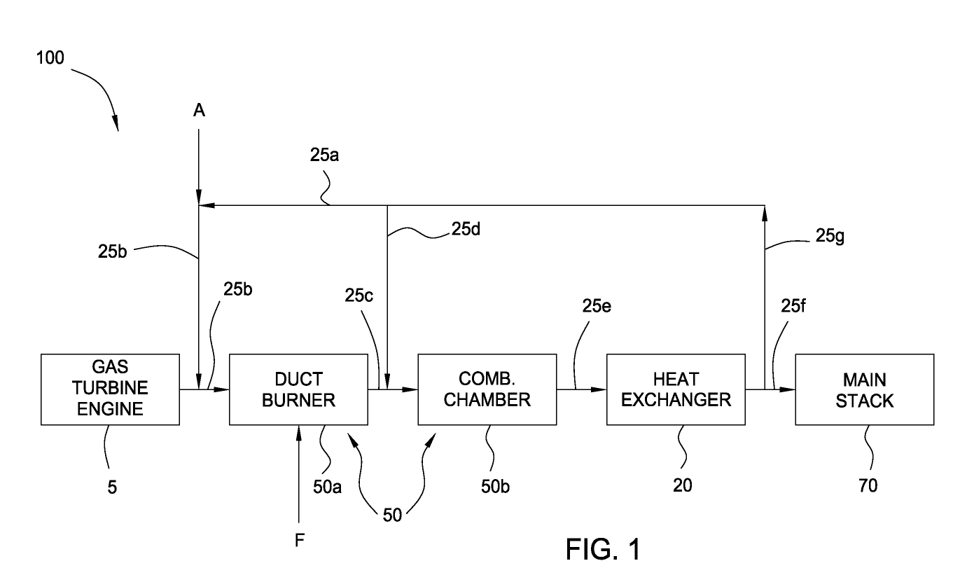

FIG. 1 is a process flow diagram of a cogeneration system 100, according to one embodiment of the present invention. The cogeneration system 100 includes a gas turbine engine 5, a furnace 50, at least one heat exchanger 20, and a main stack 70. The furnace 50 and the heat exchanger 20 are typically referred to as a heat recovery steam generator. The cogeneration system 100 is operable in either cogeneration mode or fresh air mode. In cogeneration mode, the gas turbine engine 5 is operating, whereas, in fresh air mode, the gas turbine engine 5 is shut-down. The furnace 50 includes a combustion chamber 50b and a duct burner 50a connected to a fuel supply F. The furnace 50 provides an alternate source of hot gas for steam generation in fresh air mode.

A first stream 25a of exhaust gas is mixed with a stream of fresh air A, thereby forming a first mixture 25b. The first mixture 25b is ignited with a stream of fuel F in the duct burner 50a, thereby forming a second mixture 25c. The second mixture 25c is mixed with a second stream 25d of the exhaust gas. Combustion of the second mixture 25c and mixing of the combusted second mixture with the second stream 25d of the exhaust gas occurs in the combustion chamber 50b, discussed below. The third stream 25e of the exhaust gas results from mixture of the combusted second mixture 25c with the second stream 25d of the exhaust gas. Heat energy is extracted from the third stream 25e of the exhaust gas in the heat exchanger 20 to produce steam. The third stream 25e of the exhaust gas is divided into at least a fourth stream 25f of exhaust gas and a fifth stream 25g of the exhaust gas. The fifth stream 25g of the exhaust gas is divided into at least the first stream 25a of exhaust gas and the second stream 25d of the exhaust gas. The fourth stream of exhaust gas may be released into the atmosphere at the main stack 70.

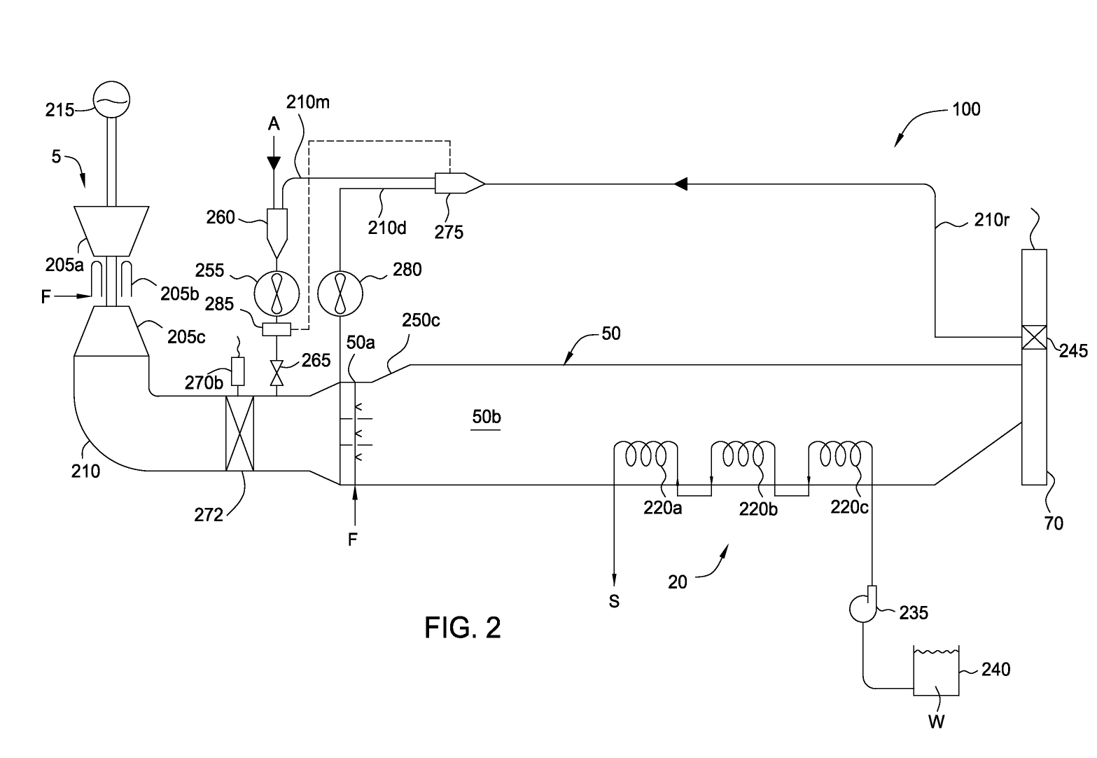

FIG. 2 is a schematic diagram of the cogeneration system 100, according to one embodiment of the present invention. The gas turbine engine 5 includes a compressor 205a, a combustor 205b (with a fuel supply F), and a turbine 205c. The gas turbine engine 5 is coupled to a generator 215. The combusted products from the gas turbine engine 5 are exhausted into a main exhaust duct 210. Disposed in the exhaust duct 210 are one or more heat exchangers 20: a super-heater 220a, an evaporator 220b, and an economizer 220c. Since the super-heater 220a is disposed closest to the turbine 205c, it is exposed to the highest temperature combustion products, followed by the evaporator 220b and the economizer 220c.

Feed-water W is pumped through these exchangers 220a,b,c from feed-water tank 240 by feed-water circulation pump 235. The feed-water W first passes through the economizer 220c. At this point, the exhaust gas is usually below the saturation temperature of the feed-water W. The term saturation temperature designates the temperature at which a phase change occurs at a given pressure. The exhaust gas is cooled by the economizer 220c to lower temperature levels for greater heat recovery and thus efficiency. The heated feed-water W then passes through the evaporator 220b where it achieves saturation temperature and is at least substantially transformed into steam S. The steam S then proceeds through the super-heater 220a where further heat energy is acquired to raise the temperature above saturation, thereby increasing the availability of useful energy therein. The superheated steam S is then transported for utilization in other processes. It is through this process that useful energy is harvested from the turbine exhaust gas. The turbine exhaust gas is expelled into the atmosphere at the main stack 70.

To enable operation of the fresh air mode, the furnace 50 is disposed in the exhaust duct 210. A by-pass stack 270b and by-pass damper 272 are used for transition between cogeneration mode and fresh air mode. The by-pass damper 272 also prevents air leakage into the gas turbine engine 5 during fresh air mode. To increase the efficiency of the fresh air mode, a diverter damper 245 is disposed in the main stack 70 so that a stream 25g of the exhaust gas may be recirculated back to the furnace 50. Alternatively, the diverter damper 245 could be located in the exhaust duct 210 at a location downstream of the economizer 220c. The recycled exhaust gas 25g stream is transported from the diverter damper 245 by a recirculation duct 210r. The recirculation duct 210r carries the stream 25g of exhaust gas to a mixing duct 260 where the stream 25g of exhaust gas is mixed with a stream A of fresh air. A damper 265 is provided to shut in the recirculation duct 210r during cogeneration mode.

A fan 255 provides the necessary power for recirculation of the stream exhaust gas and mixing thereof with the fresh air A. The fresh air/exhaust gas mixture 25b is usually injected into the exhaust duct 210 at a distance upstream of the furnace 250 to allow complete mixing of the exhaust gas with the fresh air. The mixture 25b then travels to an inlet 250c of the combustion chamber 50b. The mixture 25b then travels through the exhaust duct 210 to the duct burner 250a where it is ignited with fuel F. The ignited mixture 25c then travels into the combustion chamber 250b where the combustion process is completed.

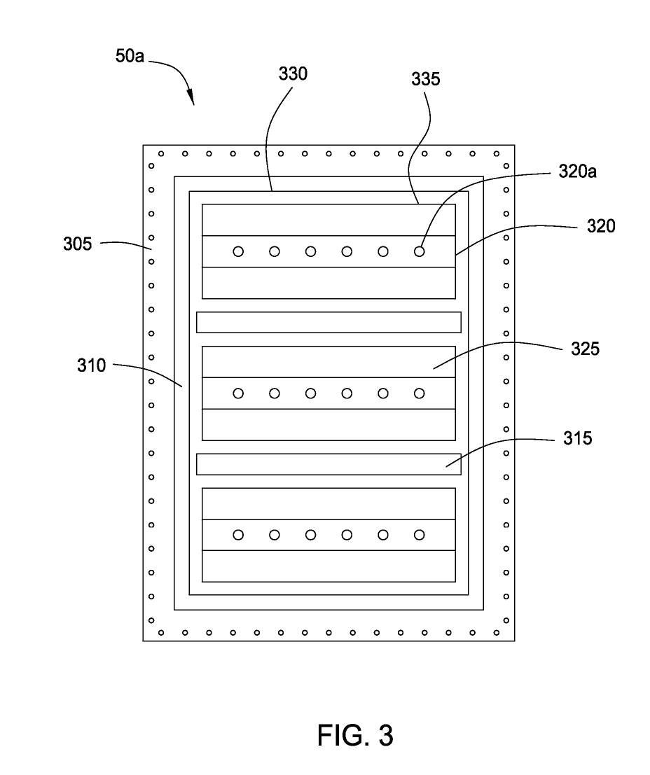

A diverter damper 275 is disposed in the recirculation duct 210r. The diverter damper 275 diverts a portion 25d of the recycled exhaust gas stream 25g (before fresh air is added) through a diverted recycled exhaust (DRE) gas sub-duct 210d to a fan 280 to increase the pressure of the diverted recycled gas 25d. Then, the DRE gas 25d is injected through bypass ports 310, 315 (see FIG. 3) in the modified duct burner 50a into the inlet 50c of the combustion chamber. Alternatively, the DRE sub-duct may be located at any axial location along the combustion chamber 50b. The remaining recycled gas 25a continues through recirculation sub-duct 210m. An oxygen sensor 285 is disposed in the recirculation sub-duct 210 and is in electrical communication with a controller 275c in the diverter damper 275. The controller 275c adjusts the portion of DRE gas 25d in order to maintain a predetermined oxygen concentration (discussed below) in the recirculation sub-duct 210m. The controller 275c is a device configured by use of a keypad or wireless interface with machine operable code to execute desired functions. The controller 275c includes a microprocessor for executing instructions stored in a memory unit.

FIG. 3 is a simplified end view of the duct burner 50a, according to one embodiment of the present invention. The end of the duct burner 50a shown is the end that faces the combustion chamber 50b. The duct burner 50a includes a flange 305 having holes for receiving fasteners to couple the end to the inlet 250c of the combustion chamber 250b. A frame 330 is coupled to the flange 305. A peripheral duct 310 is formed between the flange and the frame. One or more (preferably three) major ducts 335 and one or more (preferably two) minor ducts 315 are formed within the frame 330. The major ducts 335 are in fluid communication with the exhaust duct 210. A burner 320 is disposed in each of the major ducts 335. Each burner 320 includes a plurality of nozzles 320a in fluid communication with the fuel line F. The minor ducts 315 and the peripheral duct 310 are in fluid communication with the DRE duct 210d and extend to the inlet 250c of the combustion chamber, thereby bypassing the burners 320.

In operation, the fresh air and recycled gas mixture 25b flows through the major ducts 335 and begins combustion when it reaches the burners 320. The DRE gas 25d flows through the peripheral 310 and minor ducts 315 and converges with the ignited mixture 25c at the inlet 250c of the combustion chamber 250. However, substantial mixing of the DRE gas 25d with the ignited mixture 25c does not occur until the gases reach the distal portion of the combustion chamber 50b, whereas, substantial combustion occurs at a proximal portion of the combustion chamber 50b. This effect is provided in at least part by a configuration of the fans 255, 280, duct areas in the modified duct burner 250a, and duct placement in the modified duct burner 250 so that the velocity of the DRE gas 25d is greater (preferably, substantially greater) than the velocity of the ignited mixture 25c. The velocity and flow pattern of the forcefully injected DRE gas 25d also depend on the size and the geometry of the combustion chamber 50b, the velocity and the temperature of combustion gases, and the structure of the heat exchangers 20. The optimal velocity ratio and the turbulent intensity are dependent on specific configurations of the cogeneration system 100. For example, if the combustion chamber 50b has a length of eighteen feet and an estimated flame length from the duct burner 50a is twelve feet, then substantial mixing of the DRE gas 25d with the ignited mixture 25c would preferably occur proximate to an end of the flame distal from the duct burner 50a. The example is illustrative only as the length of the combustion chamber and the flame length vary with different cogeneration systems.

### EXAMPLES

Table 1 exhibits the beneficial effect of diverting a portion of the recycled exhaust gas and injecting the diverted recycled gas (DRE) gas 25d downstream of the burner 50b. The DRE entries marked by an “X” were simulated with the cogeneration system 100 operating in fresh air mode, whereas, the entries not marked were simulated for a conventional recycled gas cogeneration system operating in fresh air mode. The recirculation rate column for the DRE entries reflect an overall rate measured at the deflection damper 245. In each of the DRE entries, the diverter controller 275c was set to maintain acceptable oxygen content to the duct burner 50a (measured in the recirculation sub-duct 210) for stable combustion of between about 18% and about 18.5%, thereby improving the global efficiency of the cogeneration system 100. Alternatively, but less preferably, the diverter controller may be set to maintain the oxygen content at about 17.5% and, least preferably, at about 17%, according to one embodiment of the present invention (depending on specific burner and combustion chamber configuration). In the conventional cognation system, when increased rates (greater than or equal to about 30%) of recycled exhaust gas are completely mixed with fresh air and then sent back to the duct burner 50b of the furnace 50, the oxygen contents to the burner are significantly reduced. If a DRE system 100 is used, the oxygen content to the burner is maintained at a level that is acceptable for stable combustion up to at least a 45% recirculation rate and possibly as high as 60%, according to one embodiment of the present invention. In the DRE cases, power loss attributable to fan 280 has been neglected.

TABLE 1
Comparison of DRE Cogeneration System to Conventional
Cogeneration System Operating in Fresh Air Mode

| | Recirculation | Global | O₂ | O₂ |
|---|---|---|---|---|
| DRE | Rate | Efficiency | To Burner | In Exhaust Gas |
| | 0% | 83% | 20.7% | 13.5% |
| | 20% | 85.8% | 18.9% | 11.9% |
| | 30% | 87.2% | 17.45% | 10.6% |
| X | 30% | 87.2% | 18.63% | 10.6% |
| | 40% | 88.8% | 16% | 9.3% |
| X | 40% | 88.8% | 18.4% | 9.3% |
| | 45% | 89.6% | 14.6% | 7.98% |
| X | 45% | 89.6% | 18% | 7.98% |

In one embodiment, the DRE cogeneration system 100 is capable of maintaining a substantially constant oxygen concentration in the duct burner 50a at different recirculation rates of the DRE gas. Different recirculation rates give a cogeneration system the greater flexibility for design while relatively constant oxygen content to the burner facilitates better control of combustion in the system 100.

Alternatively, the DRE may also be used in cogeneration mode and in other steam generation systems, such as combined cycle systems and any system using a heat recovery steam generator or integrated boiler system.

Preferred processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

What is claimed is:

1. A method for generating heat energy, comprising:
a) mixing a first stream of exhaust gas with a stream of fresh air, thereby forming a first mixture;
b) igniting the first mixture with a stream of fuel, thereby forming a second mixture;
c) mixing the second mixture with a second stream of exhaust gas, thereby forming a third stream of exhaust gas;
d) dividing the third stream of the exhaust gas into at least a fourth stream of exhaust gas and a fifth stream of the exhaust gas; and
e) dividing at least a portion of the fifth stream of the exhaust gas into at least the first stream of exhaust gas and the second stream of the exhaust gas.

2. The method of claim 1, wherein the fifth stream of the exhaust gas is between about 30% to about 60% of the third stream.

3. The method of claim 1, wherein the act of dividing the fifth stream is controlled to maintain a predetermined oxygen concentration in the first mixture.

4. The method of claim 3, wherein the predetermined oxygen concentration is between about 17% and about 18.5%.

5. The method of claim 1, wherein the velocity of the second stream of exhaust gas is greater than the velocity of the second mixture.

6. The method of claim 1, wherein the velocity of the second stream of exhaust gas is substantially greater than the velocity of the second mixture.

7. The method of claim 1, wherein the second mixture is substantially combusted before mixing with the second stream of the exhaust gas.

8. The method of claim 1, further comprising flowing the third stream of the exhaust gas through a heat exchanger to convert water into steam.

9. The method of claim 1, further comprising:
operating a gas turbine engine of a cogeneration system in which steps a)-e) are performed; and
shutting down the gas turbine engine prior to mixing the first stream of exhaust gas with the stream of fresh air during a fresh air mode of operation of the cogeneration system.

10. The method of claim 1, further comprising releasing the fourth stream of the exhaust gas into the atmosphere.

11. A steam generator, comprising:
a) a main duct;
b) a furnace in fluid communication with the main duct, comprising:
i) a combustion chamber having a first axial end and a second axial end; and
ii) a burner located proximate to the first axial end;
c) a heat exchanger having a first chamber physically separate from and in thermal communication with a second chamber, the first chamber either in fluid communication with the main duct or being part of the main duct, the first chamber in fluid communication with the second axial end of the combustion chamber; and
d) a recirculation system, comprising:
i) a first diverter damper in fluid communication with the first chamber of the heat exchanger and a recycle duct;
ii) the recycle duct in fluid communication with the diverter damper a second diverter damper;
iii) the second diverter damper in fluid communication with the recycle duct and first and second recycle sub-ducts;
iv) a mixing damper in fluid communication with the first recycle sub-duct and fresh air;
v) the first recycle sub-duct in fluid communication with the main duct at a location distal from the first end of the combustion chamber; and
vi) the second recycle sub-duct in fluid communication with the first end of the combustion chamber at a location proximate to the burner.

12. The steam generator of claim 11, wherein the recirculation system further comprises an oxygen sensor disposed in the first recycle sub-duct, the second diverter damper comprises a controller, and the oxygen sensor is in electrical communication with the controller.

13. The steam generator of claim 11, wherein the burner is a duct burner having a bypass duct in fluid communication with the second recycle sub-duct.

14. The steam generator of claim 11, further comprising a fan disposed in the second recycle sub-duct.

15. The steam generator of claim 11, further comprising a feed-water tank; and a feed-water pump in fluid communication with the second chamber of the heat exchanger and the feed-water tank.

16. The steam generator of claim 11, further comprising a gas turbine engine in fluid communication with the main duct.

17. The steam generator of claim 11, further comprising second and third heat exchangers, wherein the third heat exchanger is located proximate to the second axial end of the combustion chamber, the heat exchanger is located distal from the second axial end of the combustion chamber, and the second exchanger is located between the other two exchangers.

18. A control system for use with a cogeneration system, comprising:
a) a memory unit containing a set of instructions;
b) a diverter damper configured to variably divide at least a portion of a first stream of recycled exhaust gas into at least a second stream and a third stream, wherein the second stream is mixed with fresh air to form a mixture;
c) an oxygen sensor configured to measure an oxygen concentration of the mixture, the oxygen sensor in electrical communication with a processor; and
d) a processor configured to control operation of the diverter damper and perform an operation, when executing the set of instructions, comprising:
i) comparing the measured oxygen concentration of the mixture with a predetermined oxygen concentration; and
ii) if the measured oxygen concentration is not substantially equal to the predetermined oxygen concentration, then adjusting the diverter damper so that the measured oxygen concentration will be substantially equal to the predetermined oxygen concentration.

19. The method of claim 18, wherein the predetermined oxygen concentration is between about 17% and about 18.5%.

20. The method of claim 18, wherein the mixture is ignited in a duct burner and the third stream is mixed with the ignited mixture downstream from the duct burner.

21. The method of claim 18, wherein the mixture is introduced into a duct burner and the third stream is mixed with the exhaust of the duct burner downstream from the duct burner.

22. A method for generating heat energy, comprising:
a) operating a cogeneration system in a first mode in which a gas turbine engine is operated to produce energy; and
b) operating the cogeneration system in a second mode in which the gas turbine engine disabled and a steam generation system operates to generate energy, wherein the operation in the second mode comprises:
i) flowing a combustible mixture into an ignition unit in order to combust the combustible mixture and produce exhaust gas;
ii) introducing a first recirculated portion of the exhaust gas at a location of the steam generation system upstream of the ignition unit; and
iii) introducing a second recirculated portion of the exhaust gas at a location of the steam generation system downstream of the ignition unit.
